(19) United States
(12) Patent Application Publication
(10) Pub. No.: US 2025/0136409 A1
(43) Pub. Date: May 1, 2025

(54) AUDIBLE FEEDBACK DEVICE

(71) Applicant: Otis Elevator Company, Farmington, CT (US)

(72) Inventors: Camilo Cardona, Avon, CT (US); Kathleen Nicole Moore, West Hartford, CT (US); James Tilsley Auxier, Palm Beach Gardens, FL (US); Christine Nicole Vanek, Chicago, IL (US)

(21) Appl. No.: 18/498,456

(22) Filed: Oct. 31, 2023

(51) Int. Cl. B66B 3/02; B66B 1/34; B66B 19/00

(52) U.S. Cl. CPC B66B 3/023; B66B 1/3492; B66B 19/007

(57) ABSTRACT

A standalone device is provided for use with a cab of a transportation system. The standalone device includes a mounting by which the standalone device is attachable to a cab body in an interior thereof, with the cab body being configured to travel between first and second locations and to accommodate at least one person in the interior while traveling. The standalone device further includes a sensor configured to sense a location of the cab body, a speaker and a processing board operably coupled to the sensor and the speaker. The processing board is configured to determine the location of the cab body from sensing results of the sensor and to control the speaker to audibilize a description of the location to the persons.

### BACKGROUND

The present disclosure relates to transportation systems, such as elevator systems, and, in particular, to a system which provides audible feedback to passengers.

In a transportation system, such as an elevator system, a hoistway is built into a building and an elevator car travels up and down along the hoistway to arrive at landing doors of different floors of the building. The elevator car is attached to an end of a suspension belt. A counterweight is attached to the other end of the suspension belt. The movement of the elevator car is driven by a machine that is controlled by a controller according to instructions received from users of the elevator system. When those instructions dictate that the elevator car should move upwardly through the hoistway, the machine rotates in one direction causing the elevator car to move upwardly and the counterweight to move downwardly. Conversely, when the instructions dictate that the elevator car should move downwardly through the hoistway, the machine rotates in an opposite direction causing the elevator car to move downwardly and the counterweight to move upwardly.

While the elevator car can be used to transport persons from one floor to another in a building, other types of conveyances exist for other applications. These include, but are not limited to, cable cars and trams that can operate in generally similar manners as elevator cars.

### SUMMARY

According to an aspect of the disclosure, a standalone device is provided for use with a cab of a transportation system. The standalone device includes a mounting by which the standalone device is attachable to a cab body in an interior thereof, with the cab body being configured to travel between first and second locations and to accommodate at least one person in the interior while traveling. The standalone device further includes a sensor configured to sense a location of the cab body, a speaker and a processing board operably coupled to the sensor and the speaker. The processing board is configured to determine the location of the cab body from sensing results of the sensor and to control the speaker to audibilize a description of the location to the persons.

In accordance with additional or alternative embodiments, the standalone device further includes a power source for powering operations of at least the sensor, the speaker and the processing board.

In accordance with additional or alternative embodiments, the standalone device further includes an interface configured to interface with an operator at least for initiating a calibration operation.

In accordance with additional or alternative embodiments, the calibration operation includes positional calibration, numbering scheme setup and options setup.

In accordance with additional or alternative embodiments, the calibration operation is automated.

In accordance with additional or alternative embodiments, for cases in which the body travels to at least the first and second locations, the calibration operation includes the sensor sensing the at least the first and second locations upon the cab body arriving thereat and the processing board determining the at least the first and second locations of the cab body from the sensing results of the sensor and generating an audibilization of the description in accordance with determination results.

In accordance with additional or alternative embodiments, the description includes at least one or more of a numeric announcement, a descriptive announcement and an instructional announcement.

In accordance with additional or alternative embodiments, the processing board includes a processor configured to generate the description via a machine learning algorithm.

According to an aspect of the disclosure, a transportation system cab is provided and includes a cab body defining an interior and configured to travel between first and second locations and to accommodate one or more person in the interior while traveling and a standalone device. The standalone device includes a mounting by which the standalone device is attachable to the cab body in the interior, a sensor configured to sense a location of the cab body, a speaker and a processing board operably coupled to the sensor and the speaker. The processing board is configured to determine the location of the cab body from sensing results of the sensor and to control the speaker to audibilize a description of the location to the persons.

In accordance with additional or alternative embodiments, the cab body is at least one of an elevator car configured to travel between floors of a building in a hoistway, a cable car configured to travel laterally along a line and a tram configured to travel laterally along tracks.

In accordance with additional or alternative embodiments, the standalone device further includes a power source for powering operations of at least the sensor, the speaker and the processing board.

In accordance with additional or alternative embodiments, the standalone device further includes the standalone device further includes an interface configured to interface with an operator at least for initiating a calibration operation.

In accordance with additional or alternative embodiments, the calibration operation includes positional calibration, numbering scheme setup and options setup.

In accordance with additional or alternative embodiments, the calibration operation is automated.

In accordance with additional or alternative embodiments, the calibration operation includes the cab body traveling to at least the first and second locations, the sensor sensing the at least the first and second locations upon the cab body arriving thereat and the processing board determining the at least the first and second locations of the cab body from the sensing results of the sensor and generating an audibilization of the description in accordance with determination results.

In accordance with additional or alternative embodiments, the description includes at least one or more of a numeric announcement, a descriptive announcement and an instructional announcement.

In accordance with additional or alternative embodiments, the processing board includes a processor configured to generate the description via a machine learning algorithm.

According to an aspect of the disclosure, a method of retrofitting a cab of a transportation system is provided. The method includes mounting a standalone device to a cab body in an interior thereof, driving the cab body to travel between first and second locations, determining a location of the cab body from sensing results of a sensor of the standalone device and controlling a speaker of the standalone device to audibilize a description of the location.

In accordance with additional or alternative embodiments, the method further includes executing a calibration operation including driving the cab body to travel to at least the first and second locations, sensing the at least the first and second locations upon the cab body arriving thereat, determining the at least the first and second locations of the cab body from results of the sensing and generating an audibilization of the description in accordance with determination results.

In accordance with additional or alternative embodiments, the description includes at least one or more of a numeric announcement, a descriptive announcement and an instructional announcement and the method further includes generating the description via a machine learning algorithm.

According to an aspect of the disclosure, a method of operating a mobile application is provided for use with a cab body of a transportation system. The method is executable by a mobile computing device which is disposable in an interior of the cab body and includes recording a schematic of the transportation system, identifying discrete locations of the transportation system from the schematic, generating a description of each of the discrete locations, determining that the mobile computing device is in the interior of the cab body and a location of the cab body in the transportation system and, in an event the mobile computing device is in the interior of the cab body and the location of the cab body is one of the discrete locations, audibilizing the description of the one of the discrete locations.

In accordance with additional or alternative embodiments, the transportation system includes at least one of an elevator system in which the cab body is an elevator car configured to travel between floors of a building in a hoistway, a cable car system in which the cab body is a cable car configured to travel laterally along a line and a tram system in which the cab body is a tram configured to travel laterally along tracks.

In accordance with additional or alternative embodiments, the method further includes downloading the schematic of the transportation system.

In accordance with additional or alternative embodiments, the identifying of the discrete locations includes at least one of identifying the discrete locations directly from the schematic, receiving an input identifying the discrete locations and executing a machine learning algorithm.

In accordance with additional or alternative embodiments, the determining of the location of the cab body includes at least one of a sensing of the location of the cab body, receiving a signal corresponding to the location of the cab body and receiving an input corresponding to the location of the cab body.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a perspective view of an elevator system in accordance with embodiments;

FIG. 2 is a schematic illustration of a body of a cab of an elevator car in a hoistway in accordance with embodiments;

FIG. 3 is a schematic illustration of a body of a cab of a cable car on a line in accordance with embodiments;

FIG. 4 is a schematic illustration of a body of a cab of a tram on tracks in accordance with embodiments;

FIG. 5 is a schematic diagram of a standalone device of the cab of FIGS. 2-4 in accordance with embodiments;

FIG. 6 is a schematic diagram of a processing board of the standalone device of FIG. 5 in accordance with embodiments;

FIG. 7 is a flow diagram illustrating a method of retrofitting a cab with a standalone device in accordance with embodiments; and

FIG. 8 is a flow diagram illustrating a method of operating a mobile application for use with a cab body of a transportation system in accordance with embodiments.

### DETAILED DESCRIPTION

Recent feedback from visually impaired communities overwhelmingly indicates that a problem with some elevators is they do not have audible feedback to indicate the floor position. Meanwhile, it has been found that visually impaired individuals can have difficulties counting tones to determine if they have reached their destination floor. This is especially true for elevator systems with multiple banks where an elevator doesn't service all floors (e.g., an elevator serving the lobby and floors 9-16) and where certain floors are skipped in a numbering scheme (e.g., floor 13). Similar issues exist with other types of conveyances, such as, but not limited to, cable cars and trams.

Thus, as will be described below, a standalone, edge computing device is provided. The device can be calibrated to know and audibly announce (i.e., hereinafter referred to as “audibilize”) the floor positions or locations in a jobsite, a building or some other structure that people need to move around or through. The device can include a mounting device (e.g., magnetic, adhesive, fastener, etc.) that can be retrofit to a cab, an accelerometer, a processor programmed to convert accelerometer input into a position signal and with stored voice tones for numbers 0, 1, 2, 3, 4, etc., and basic words such as parking, ground, lobby, etc., a speaker that can be actuated by the processor, and power source in the form of a battery, a USB charging port and/or or a power source in the cab. The device can be wired or wireless. Also, the device can include an interface to a smartphone or a simple set of buttons that can be used to calibrate floor positions, set the numbering scheme and set options such as advancing or delaying voice tones. The device can be set to an automated calibration mode to learn the floor position at every stop of the elevator (or other type of conveyance) if the elevator (or the other type of conveyance) is set to stop at every floor during a calibration run. In addition, the device could receive an external signal from a landing, such as from a permanent magnet, at certain floors or locations that could re-zero the calibration, particularly for taller applications and/or rougher rides where accelerometer drift is a possibility.

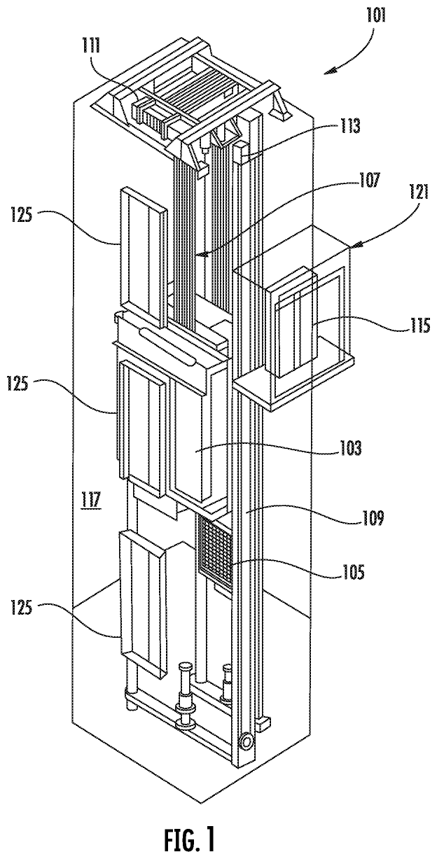

With reference to FIG. 1, which is a perspective view of an elevator system 101, the elevator system 101 includes an elevator car 103, a counterweight 105, a tension member or tension member 107, a guide rail 109, a machine 111, a position reference system 113 and a controller 115. The elevator car 103 and the counterweight 105 are connected to each other by the tension member 107. The tension member 107 may include or be configured as, for example, ropes, coated ropes, steel cables and/or coated-steel belts. The counterweight 105 is configured to balance a load of the elevator car 103 and is configured to facilitate movement of the elevator car 103 concurrently and in an opposite direction with respect to the counterweight 105 within a hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the hoistway 117, such as on a support or guide rail, and may be configured to provide position signals related to a position of the elevator car 103 within the hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 may be located, as shown, in a controller room 121 of the hoistway 117 and is configured to control the operation of the elevator system 101, and particularly the elevator car 103. It is to be appreciated that the controller 115 need not be in the controller room 121 but may be in the hoistway or other location in the elevator system. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to the tension member 107 to move the elevator car 103 within hoistway 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes. In other embodiments, the system includes a conveyance system that moves passengers between floors and/or along a single floor. Such conveyance systems may include escalators, people movers, etc. Accordingly, embodiments described herein are not limited to elevator systems, such as that shown in FIG. 1.

The elevator system 101 also includes one or more elevator doors 104. The elevator door 104 may be integrally attached to the elevator car 103 or the elevator door 104 may be located on a landing 125 of the elevator system 101, or both. Embodiments disclosed herein may be applicable to both an elevator door 104 integrally attached to the elevator car 103 or an elevator door 104 located on a landing 125 of the elevator system 101, or both. The elevator door 104 opens to allow passengers to enter and exit the elevator car 103.

With continued reference to FIG. 1 and with additional reference to FIGS. 2-4 and to FIG. 5, a standalone device 201 is provided. The standalone device 201 includes a mounting 210 and a cab body 211 that is formed to define an interior in which one or more person (i.e., passengers) can be accommodated. The mounting 210 serves to mount the standalone device 201 to the cab body 211 in the interior 212. As used herein, the term “interior” can include the interior or exterior of the car-operation-panel (COP) with the mounting 210 being in front of or behind the COP door. The mounting 210 can include or be provided as at least one or more of a magnetic mounting, an adhesive and fasteners. The cab body 211 can include or be provided as a cab of an elevator car, such as the elevator car 103 of FIG. 1 (see FIG. 2), or as a cable car 301 that travels along a line 302 (see FIG. 3) or as a tram 401 that travels along tracks 402 (see FIG. 4) or as any other similar and/or suitable cab body. In any case, the cab body 211 (hereinafter, the following description will relate to the case of the standalone device 201 being provided in the cab body 211 where the cab body 211 is the elevator car 103; this is being done for purposes of clarity and brevity and should not otherwise limit the scope of the application or the claims in any way) is configured to travel between first and second locations (i.e., first and second floors or landings of a building) and to accommodate persons in the interior 212 while traveling.

As shown in FIG. 5, the standalone device 201 further includes a sensor 510 that is configured to sense a location of the cab body 211, a speaker 520 and a processing board 530. The sensor 510 can be provided as any type of sensor including, but not limited to, a Hall effect sensor, an electromagnetic or inductive sensor, a LiDAR sensor, a radar sensor and a camera. The standalone device 201 can further include a power source 540 and an interface 550. The processing board 530 is operably coupled to each of the sensor 510, the speaker 520, the power source 540 and the interface 550. The power source 540 is provided to power operations of at least the sensor 510, the speaker 520, the processing board 530 and the interface 550 and may be provided as a battery, a rechargeable battery and/or a wired or wireless connection to a power supply of the cab body 211 or grid power.

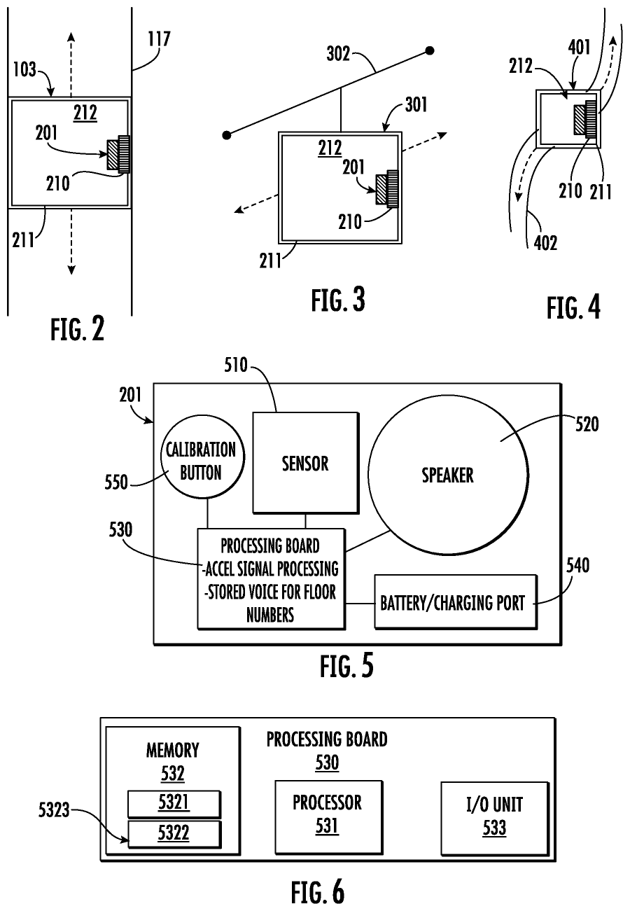

With reference to FIG. 6, the processing board 530 may include a processor 531, a memory 532 and an input/output (I/O) unit 533 by which the processor 531 is communicative with the sensor 510, the speaker 520, the power source 540 and the interface 550. The memory 532 has executable instructions stored thereon, which are readable and executable by the processor 531. When these executable instructions are read and executed by the processor 531, the executable instructions cause the processor 531 to operate as described herein. For example, the processing board 530 as a whole can be configured to determine the location of the cab body 211 from sensing results of the sensor 510 and to control the speaker 520 to audibilize a description of the location to the persons accommodated in the interior 212.

In accordance with embodiments, the description that is audibilized by the speaker 520 can include at least one or more of a numeric announcement (i.e., a floor number when the cab body 211 reaches that particular floor), a descriptive announcement (i.e., a term, such as “garage,” when the cab body 211 reaches a location or floor that does not have a numeric identifier) and an instructional announcement (i.e., a phrase, such as “proceed to the left for elevators serving floors 10-20”) when it is necessary to direct persons from one elevator to another. In any case, the processor 531 of the processing board 530 can be further configured to generate the description from stored files 5321 and/or from generated files 5322 that are generated via a machine learning algorithm 5323 that is stored on the memory 532. That is, an operator can create various descriptions for the locations that the cab body 211 is expected to arrive at during operational usages and can store those descriptions as the files 5321. In addition or as an alternative, the processor 531 can generate the descriptions as the generated files 5322 over time via the machine learning algorithm 5323 (i.e., by drawing on recordings of persons getting on/off the cab body 211, by accessing online libraries, etc.).

In accordance with embodiments, the interface 550 can be configured to interface with an operator at least for initiating a calibration operation that can be manually executed or automated. In any case, the calibration operation can include positional calibration operations to learn and calibrate floor positions or locations, numbering scheme setups to learn and calibrate numbering terms for associations with the floor positions or locations and options setups for advancing or delaying voice tones to be emitted by the speaker 520. In an exemplary instance, for cases in which the cab body 211 travels to at least the first and second locations, the calibration operation can include at least one or more of the following operations: the cab body 211 traveling to at least the first and second locations, the sensor 510 sensing the at least the first and second locations upon the cab body 211 arriving thereat and the processing board 530 determining the at least the first and second locations of the cab body 211 from the sensing results of the sensor 510 and generating an audibilization of the description in accordance with determination results.

In accordance with embodiments, the sensor 510 can sense the at least the first and second locations by various methods as set forth above and the processing board 530 can determine the at least the first and second locations of the cab body 211 from the sensing results of the sensor 510 by similarly varied methods. These include, for example, a double integration of a signal of the sensor 510 to derive a position of the cab body 211.

In an exemplary case of an elevator system servicing a multi-story building, the automated calibration operation can initiate calls for all of the floors of the multi-story building starting at the bottom floor. Where the sensor 510 is an accelerometer, for example, accelerometer data can be recorded by the processing board 530 whereupon the processor 531 can determine floor heights based on acceleration, speed and time as well as floor numbers in sequence. Once the calibration operation for all of the floors of the multi-story building is completed, each floor is associated with an appropriate audible output.

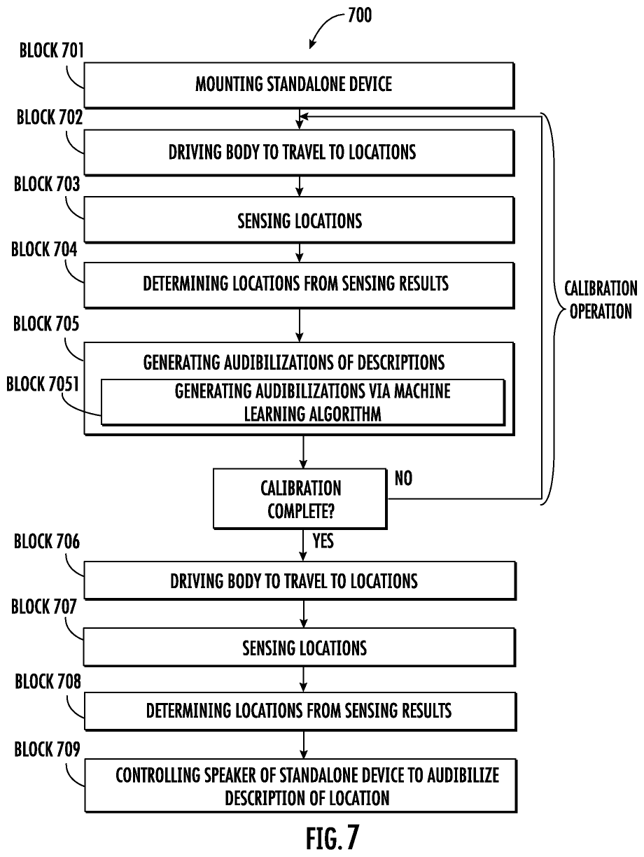

With reference to FIG. 7, a method 700 of retrofitting a cab, such as the cab provided as the elevator car 103 of FIG. 1. As shown in FIG. 7, the method 700 includes mounting a standalone device to a cab body in an interior thereof (block 701), driving the cab body to travel between first and second locations (block 706), sensing the first and second locations upon the cab body arriving thereat (block 707), determining a location of the cab body from sensing results of a sensor of the standalone device (block 708) and controlling a speaker of the standalone device to audibilize a description of the location (block 709). The method 700 can further include executing a calibration operation following the mounting of the standalone device of block 701 and prior to the driving of block 706. As shown in FIG. 7, the calibration operation can include driving the cab body to travel to at least the first and second locations (block 702), sensing the at least the first and second locations upon the cab body arriving thereat (block 703), determining the at least the first and second locations of the cab body from results of the sensing (block 704) and generating an audibilization of the description in accordance with determination results (block 705). As mentioned above, the description can include at least one or more of a numeric announcement, a descriptive announcement and an instructional announcement and the method 700 can further include generating the description via a machine learning algorithm (block 7051).

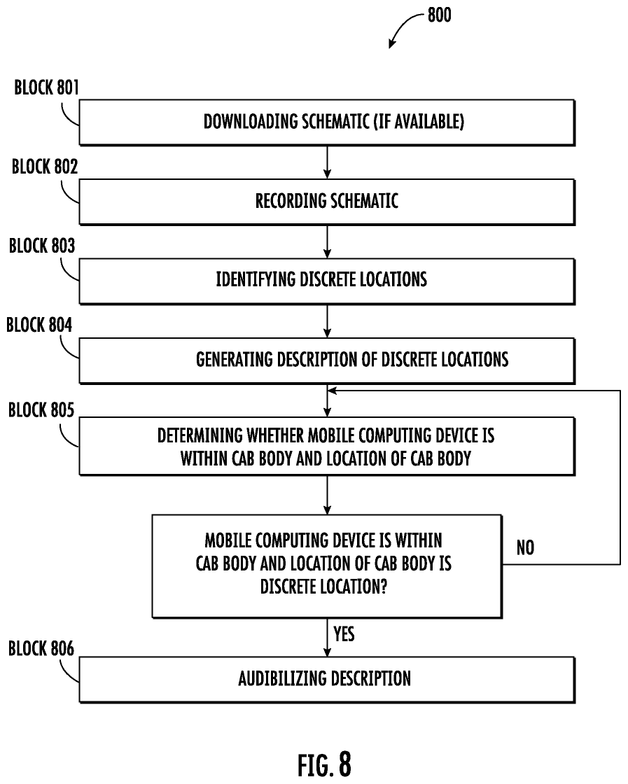

With reference to FIG. 8, for cases in which the standalone device 201 is not installed in a cab body 211, a method 800 is provided as a method of operating a mobile application for use with a cab body of a transportation system. The transportation system can include, for example, at least one or more of an elevator system in which the cab body is an elevator car configured to travel between floors of a building in a hoistway, a cable car system in which the cab body is a cable car configured to travel laterally along a line and a tram system in which the cab body is a tram configured to travel laterally along tracks. The method 800 is executable by a mobile computing device which is disposable in an interior of the cab body. The method 800 includes downloading (if available) a schematic of the transportation system (block 801), recording the schematic (block 802), identifying discrete locations of the transportation system from the schematic (block 803) and generating a description of each of the discrete locations (block 804). In accordance with embodiments, the identifying of block 803 can include at least one or more of identifying the discrete locations directly from the schematic, receiving an input identifying the discrete locations and executing a machine learning algorithm.

The method 800 further includes determining that the mobile computing device is in the interior of the cab body and a location of the cab body in the transportation system (block 805) and, in an event the mobile computing device is in the interior of the cab body and the location of the cab body is one of the discrete locations, audibilizing the description of the one of the discrete locations (block 806). In accordance with embodiments, the determining of the location of the cab body of block 805 can include at least one or more of a sensing of the location of the cab body, receiving a signal corresponding to the location of the cab body and receiving an input corresponding to the location of the cab body.

Technical effects and benefits of the present disclosure are the provision of a standalone edge computing device with improved accessibility for certain elevator systems in which elevators have not been modernized. The standalone device has a lower cost than fixture modernization, a controller that can be brand agnostic and has the ability to work in vertical, diagonal or horizontal orientations (e.g., for cable cars or trams).

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

1. A standalone device for use with a cab of a transportation system, the standalone device comprising:
a mounting by which the standalone device is attachable to a cab body in an interior thereof, the cab body being configured to travel between first and second locations and to accommodate at least one person in the interior while traveling;
a sensor configured to sense a location of the cab body;
a speaker; and
a processing board operably coupled to the sensor and the speaker,
the processing board being configured to determine the location of the cab body from sensing results of the sensor and to control the speaker to audibilize a description of the location to the persons.

2. The standalone device according to claim 1, further comprising a power source for powering operations of at least the sensor, the speaker and the processing board.

3. The standalone device according to claim 1, further comprising an interface configured to interface with an operator at least for initiating a calibration operation.

4. The standalone device according to claim 3, wherein the calibration operation comprises positional calibration, numbering scheme setup and options setup.

5. The standalone device according to claim 3, wherein the calibration operation is automated.

6. The standalone device according to claim 3, wherein, for cases in which the body travels to at least the first and second locations, the calibration operation comprises:
the sensor sensing the at least the first and second locations upon the cab body arriving thereat; and
the processing board determining the at least the first and second locations of the cab body from the sensing results of the sensor and generating an audibilization of the description in accordance with determination results.

7. The standalone device according to claim 1, wherein the description comprises at least one or more of a numeric announcement, a descriptive announcement and an instructional announcement.

8. The standalone device according to claim 1, wherein the processing board comprises a processor configured to generate the description via a machine learning algorithm.

9. A transportation system cab, comprising:
a cab body defining an interior and configured to travel between first and second locations and to accommodate one or more person in the interior while traveling;
a standalone device, comprising:
a mounting by which the standalone device is attachable to the cab body in the interior;
a sensor configured to sense a location of the cab body;
a speaker; and
a processing board operably coupled to the sensor and the speaker,
the processing board being configured to determine the location of the cab body from sensing results of the sensor and to control the speaker to audibilize a description of the location to the persons.

10. The cab according to claim 9, wherein the cab body is at least one of an elevator car configured to travel between floors of a building in a hoistway, a cable car configured to travel laterally along a line and a tram configured to travel laterally along tracks.

11. The cab according to claim 9, wherein the standalone device further comprises a power source for powering operations of at least the sensor, the speaker and the processing board.

12. The cab according to claim 9, wherein the standalone device further comprises an interface configured to interface with an operator at least for initiating a calibration operation.

13. The cab according to claim 12, wherein the calibration operation comprises positional calibration, numbering scheme setup and options setup.

14. The cab according to claim 12, wherein the calibration operation is automated.

15. The cab according to claim 12, wherein the calibration operation comprises:
the cab body traveling to at least the first and second locations;
the sensor sensing the at least the first and second locations upon the cab body arriving thereat; and
the processing board determining the at least the first and second locations of the cab body from the sensing results of the sensor and generating an audibilization of the description in accordance with determination results.

16. The cab according to claim 9, wherein the description comprises at least one or more of a numeric announcement, a descriptive announcement and an instructional announcement.

17. The cab according to claim 9, wherein the processing board comprises a processor configured to generate the description via a machine learning algorithm.

18. A method of retrofitting a cab of a transportation system, the method comprising:
mounting a standalone device to a cab body in an interior thereof;
driving the cab body to travel between first and second locations;
determining a location of the cab body from sensing results of a sensor of the standalone device; and
controlling a speaker of the standalone device to audibilize a description of the location.

19. The method according to claim 18, further comprising executing a calibration operation comprising:
driving the cab body to travel to at least the first and second locations;
sensing the at least the first and second locations upon the cab body arriving thereat;
determining the at least the first and second locations of the cab body from results of the sensing; and
generating an audibilization of the description in accordance with determination results.

20. The method according to claim 18, wherein:
the description comprises at least one or more of a numeric announcement, a descriptive announcement and an instructional announcement, and
the method further comprises generating the description via a machine learning algorithm.

21-25. (canceled)
